(19) United States
(12) Patent Application Publication
(10) Pub. No.: US 2022/0161831 A1
(43) Pub. Date: May 26, 2022

(54) TRAIN PLATFORM SAFETY DEVICE FOR PREVENTING SAFETY ACCIDENT

(71) Applicant: SKD HI-TEC CO., LTD., Gwangyang-si (KR)

(72) Inventor: Sung Moo HAN, Gwangyang-si (KR)

(73) Assignee: SKD HI-TEC CO., LTD., Gwangyang-si (KR)

(21) Appl. No.: 17/102,481

(22) Filed: Nov. 24, 2020

(51) Int. Cl. B61B 1/02; E06B 11/02

(52) U.S. Cl. CPC B61B 1/02; E05Y 2900/404; E06B 11/021

(57) ABSTRACT

Provided is a train platform safety device for preventing a safety accident, the train platform safety device including: at least one pair of lift drive units 10 installed at a position selected in a section from an entrance of a platform, where a train enters, to an exit of the platform; a plurality of movable bodies 20 provided inside the lift drive units 10 so as to be movable in a vertical direction; rope groups 30A and 30B including a plurality of ropes connecting the movable bodies 20 in a horizontal direction; and an interval maintaining unit 100 configured to connect, in the vertical direction, any one rope in the rope group 30B positioned at an upper side and any one rope in the rope group 30A positioned at a lower side so that a vertical interval between the rope groups 30A and 30B is maintained when the rope groups 30A and 30B are staggered as the plurality of movable bodies 20 and the rope groups 30A and 30B are moved downward by operations of the lift drive units 10. According to the present invention, the plurality of rope groups may be connected to one another in the vertical direction to maintain the vertical interval therebetween, thereby preventing a passenger from passing between the rope groups. In addition, the present invention has an effect of minimizing sagging of the rope group. Furthermore, the present invention has an effect of improving durability and service life because the structure is simple and the maintenance may be easily performed.

### TECHNICAL FIELD

The present invention relates to a train platform safety device capable of preventing a safety accident, and more particularly, to a train platform safety device capable of preventing a safety accident by maintaining a vertical interval between rope groups.

### BACKGROUND ART

In general, as illustrated in FIG. 1, a train platform safety device includes: at least one pair of lift drive units 10 installed at a position selected in a section from an entrance of a platform, where a train enter, to an exit of the platform; a plurality of movable bodies 20 provided inside the lift drive unit 10 so as to be movable in a vertical direction; and rope groups 30A and 30B including a plurality of ropes connecting the movable bodies 20 in a horizontal direction.

In this case, the two or more movable bodies 20 are provided and moved upward by the operations of the lift drive units 10 so that the rope groups 30A and 30B are overlapped to ensure a space through which the passenger may enter the train. On the contrary, the movable bodies 20 are moved downward by the reverse operations of the lift drive units 10 so that the plurality of movable bodies 20 and the rope groups 30A and 30B are staggered, respectively, to block the passenger.

However, in the related art, a vertical interval between the plurality of rope groups 30A and 30B, which are staggered, cannot be constantly maintained, and as a result, there is a problem in that a safety accident occurs as a passenger passes and enters between the rope groups 30A and 30B.

Further, the rope groups 30A and 30B sag downward due to lengths and weights of the rope groups 30A and 30B, which causes a problem in that it is impossible to smoothly control the passengers.

### DOCUMENTS OF RELATED ART

### Patents Document

Korean Patent No. 10-0601112 (Jul. 19, 2006)
Japanese Patent Application Laid-Open No. 2008-534827 (Aug. 28, 2008)
Korean Patent No. 10-1143843 (May 4, 2012)
Korean Patent Application Laid-Open No. 10-2014-0009813 (Jan. 23, 2014)
Korean Patent Application Laid-Open No. 10-2015-0013411 (Feb. 5, 2015)
Korean Patent Application Laid-Open No. 10-2015-0013410 (Feb. 5, 2015)
Korean Patent Application Laid-Open No. 10-2014-0007980 (Jan. 20, 2014)
Korean Patent No. 10-1471543 (Dec. 11, 2014)
Korean Patent Application Laid-Open No. 10-2019-0120482 (Oct. 24, 2019)

### SUMMARY OF THE INVENTION

The present invention has been made in an effort to provide a train platform safety device capable of preventing a safety accident by connecting a plurality of rope groups in a vertical direction to maintain a vertical interval between the rope groups so that a passenger cannot pass between the rope groups.

The present invention has also been made in an effort to provide a train platform safety device capable of preventing a safety accident and preventing sagging and swaying of a rope group.

An exemplary embodiment of the present invention provides a train platform safety device for preventing a safety accident, the train platform safety device including: at least one pair of lift drive units installed at a position selected in a section from an entrance of a platform, where a train enters, to an exit of the platform; a plurality of movable bodies provided inside the lift drive units so as to be movable in a vertical direction; rope groups including a plurality of ropes connecting the movable bodies in a horizontal direction; and an interval maintaining unit configured to connect, in the vertical direction, any one rope in the rope group positioned at an upper side and any one rope in the rope group positioned at a lower side so that a vertical interval between the rope groups is maintained when the rope groups are staggered as the plurality of movable bodies and the rope groups are moved downward by operations of the lift drive units.

In this case, the lift drive unit includes: a main body provided in the vertical direction at a predetermined position on the platform; two or more rotary bodies having different diameters and installed at upper and lower sides inside the main body, respectively; a drive mean provided to rotate the rotary bodies to move the movable bodies in the vertical direction so that the plurality of movable bodies is overlapped by being moved upward or staggered by being moved downward; and a connecting body configured to connect the rotary bodies and the drive means.

In addition, the interval maintaining unit may include: an upper connecting part provided to be connected to any one rope in the rope group positioned at the upper side; a lower connecting part provided to be connected to any one rope in the rope group positioned at the lower side; and an intermediate connecting part configured to connect the upper connecting part and the lower connecting part and made of a soft material so as to be changed in shape in accordance with the positions of the plurality of rope groups which are overlapped or staggered.

In this case, the upper connecting part and the lower connecting part may be formed to slip around an outer diameter of the rope in accordance with the positions of the plurality of rope groups which are overlapped or staggered.

According to the present invention, the plurality of rope groups may be connected to one another in the vertical direction to maintain the vertical interval therebetween, thereby preventing a passenger from passing between the rope groups.

In addition, the present invention has an effect of minimizing sagging of the rope group.

Furthermore, the present invention has an effect of improving durability and service life because the structure is simple and the maintenance may be easily performed.

### BRIEF DESCRIPTION OF THE DRAWINGS

FIGS. 1 and 2 are schematic views illustrating a configuration and an operating state of a train platform safety device in the related art.

FIGS. 3 and 4 are schematic views illustrating a configuration and an operating state of a train platform safety device capable of preventing a safety accident according to the present invention.

FIG. 5 is a top plan view illustrating a configuration of a lift drive unit according to the present invention.

FIG. 6 is a perspective view illustrating a state in which a plurality of rope groups according to the present invention is staggered.

FIG. 7 is a cross-sectional view illustrating a state in which the plurality of rope groups according to the present invention is staggered.

FIG. 8 is a perspective view illustrating a state in which the plurality of rope groups according to the present invention is overlapped.

FIG. 9 is a cross-sectional view illustrating a state in which the plurality of rope groups according to the present invention is overlapped.

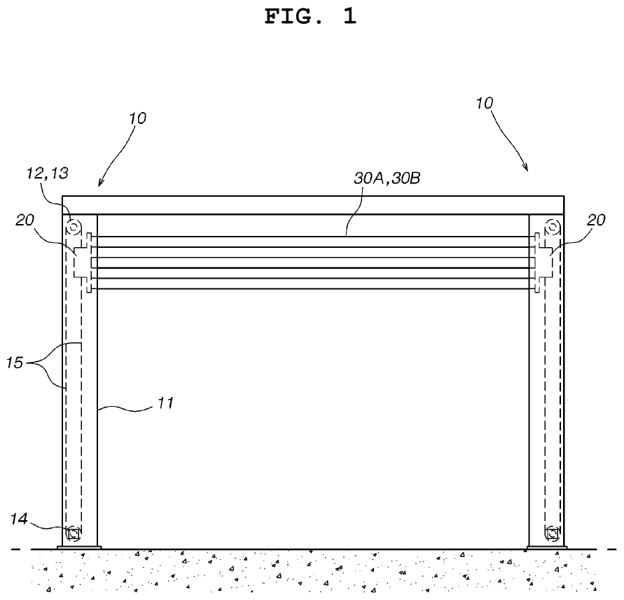

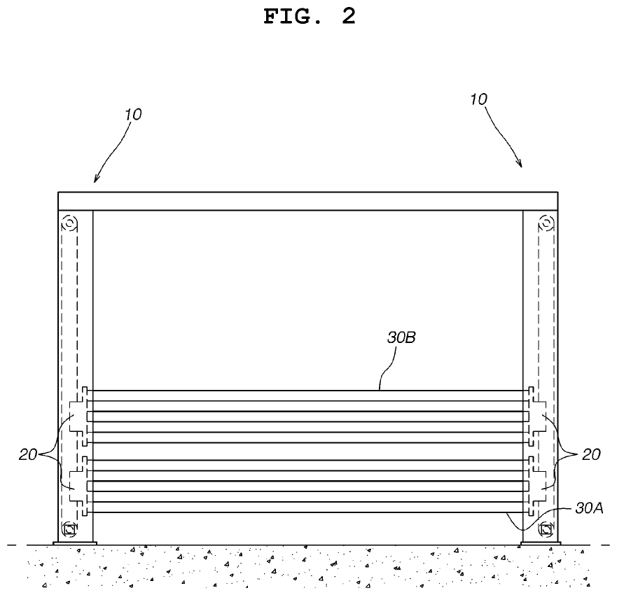

### DETAILED DESCRIPTION

The technical configuration for achieving the above-mentioned object of the present invention will be described in more detail with reference to the accompanying drawings.

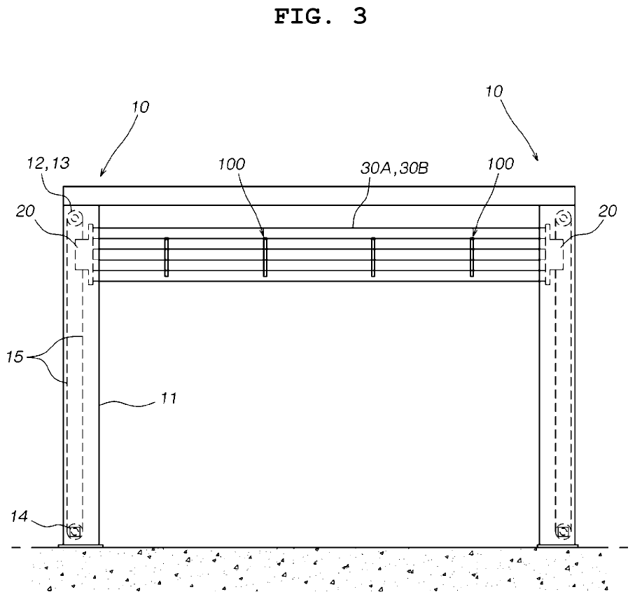

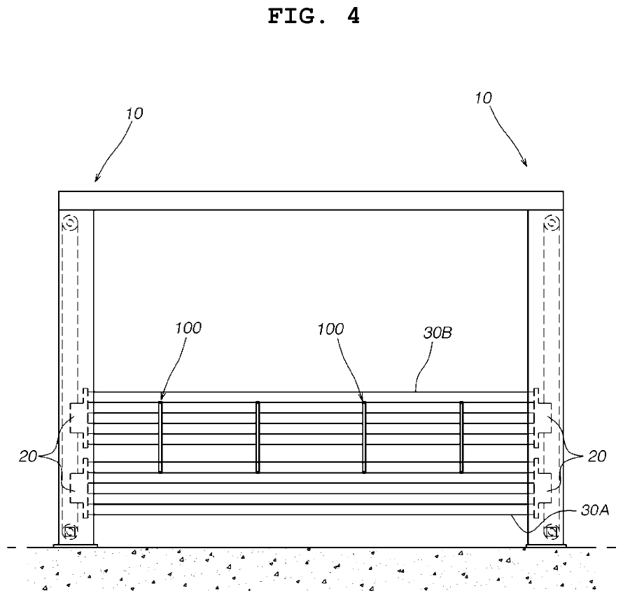

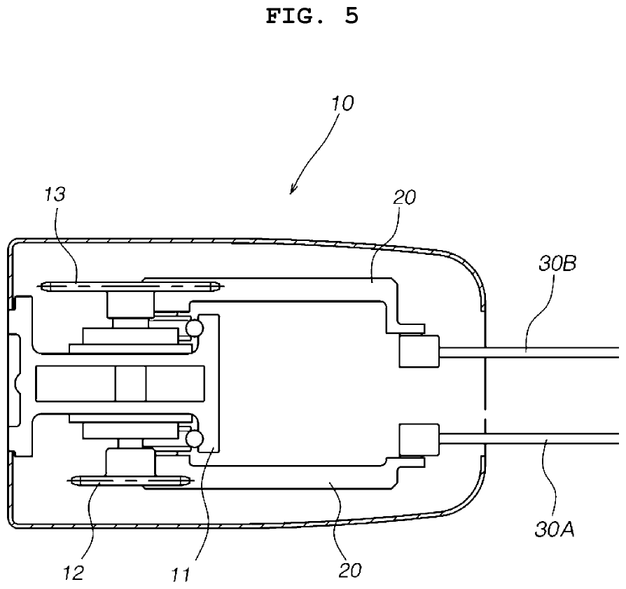

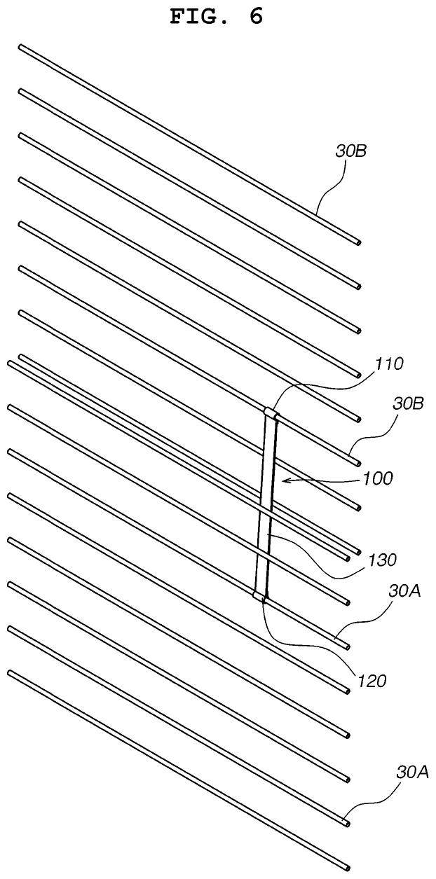

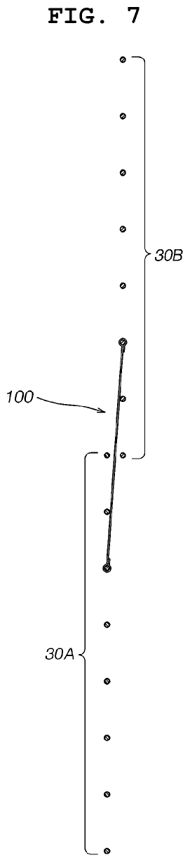

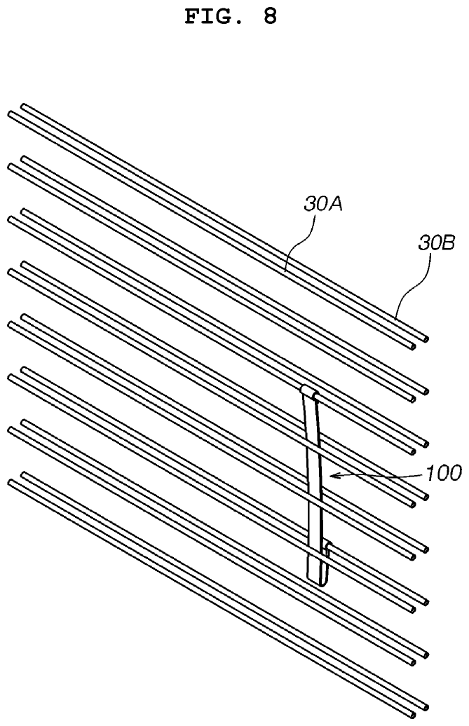

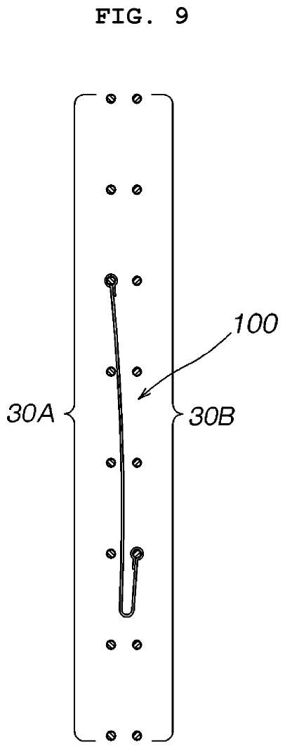

FIGS. 3 and 4 are schematic views illustrating a configuration and an operating state of a train platform safety device capable of preventing a safety accident according to the present invention, FIG. 5 is a top plan view illustrating a configuration of a lift drive unit according to the present invention, FIG. 6 is a perspective view illustrating a state in which a plurality of rope groups according to the present invention is staggered, FIG. 7 is a cross-sectional view illustrating a state in which the plurality of rope groups according to the present invention is staggered, FIG. 8 is a perspective view illustrating a state in which the plurality of rope groups according to the present invention is overlapped, and FIG. 9 is a cross-sectional view illustrating a state in which the plurality of rope groups according to the present invention is overlapped.

A train platform safety device according to the present invention includes: at least one pair of lift drive units 10 installed at a position selected in a section from an entrance of a platform, where a train enters, to an exit of the platform; a plurality of movable bodies 20 provided inside the lift drive units 10 so as to be movable in a vertical direction; rope groups 30A and 30B including a plurality of ropes connecting the movable bodies 20 in a horizontal direction; and an interval maintaining unit 100 configured to connect, in the vertical direction, any one rope in the rope group 30B positioned at an upper side and any one rope in the rope group 30A positioned at a lower side so that a vertical interval between the rope groups 30A and 30B may be maintained in a state in which the rope groups 30A and 30B are staggered as the plurality of movable bodies 20 and the rope groups 30A and 30B are moved downward by operations of the lift drive units 10.

Meanwhile, the at least one pair of lift drive units 10 is installed to face each other at the position selected in the section from the entrance to the exit of the platform.

In this case, the lift drive unit 10 includes: a main body 11 provided in the vertical direction at a predetermined position on the platform; two or more rotary bodies 12 and 13 having different diameters and installed at upper and lower sides inside the main body 11, respectively; a drive mean 14 provided to rotate the rotary bodies 12 and 13 to move the movable bodies 20 in the vertical direction so that the plurality of movable bodies 20 is overlapped by being moved upward or staggered by being moved downward; and a connecting body 15 configured to connect the rotary bodies 12 and 13 and the drive means 14.

In particular, since the rotary bodies 12 and 13 have different diameters or dimensions, the plurality of movable bodies 20 is overlapped by being moved upward or staggered by being moved downward when the drive means 14 operates to rotate the rotary bodies 12 and 13.

In this case, the diameters of the rotary bodies 12 and 13 may of course be changed depending on an upward/downward movement position and a height of the movable body 20.

In addition, a motor, a cylinder, or the like may be applied as the drive means.

Further, a sprocket or a pulley may be applied as the rotary bodies 12 and 13, and a chain or a belt may be applied as the connecting body 15.

Further, the two or more movable bodies 20 are provided and moved upward by the operations of the lift drive units 10 so that the rope groups 30A and 30B are overlapped to ensure a space through which the passenger may enter the train. On the contrary, the movable bodies 20 are moved downward by the reverse operations of the lift drive units 10 so that the plurality of movable bodies 20 and the rope groups 30A and 30B are staggered, respectively, to block the passenger.

In addition, the rope groups 30A and 30B includes the plurality of ropes spaced apart from one another at predetermined intervals in the vertical direction. An outer portion of the rope is coated with rubber or synthetic resin to not only prevent corrosion, but also minimize an injury to the passenger when the passenger collides with the rope.

In particular, the rope groups 30A and 30B connect, in the horizontal direction, the pairs of the movable bodies 20 facing one another. A single rope may be used to connect the pair of movable bodies 20 in a zigzag pattern to maintain tension thereof. Of course, a plurality of ropes may be used to connect the pair of movable bodies 20 to maintain tension thereof.

In the present invention, the interval maintaining unit 100 connects the plurality of rope groups 30A and 30B in the vertical direction, such that the vertical interval is maintained in the state in which the plurality of movable bodies 20 are staggered as the plurality of movable bodies 20 and the rope groups 30A and 30B are moved downward, thereby preventing the passenger from passing and entering between the upper and lower sides of the rope groups 30A and 30B.

As illustrated in FIGS. 6 to 9, the interval maintaining unit 100 includes: an upper connecting part 110 provided to be connected to any one rope in the rope group 30B positioned at the upper side; a lower connecting part 120 provided to be connected to any one rope in the rope group 30A positioned at the lower side; and an intermediate connecting part 130 configured to connect the upper connecting part 110 and the lower connecting part 120 and made of a soft material so as to be changed in shape in accordance with the positions of the plurality of rope groups 30A and 30B which are overlapped or staggered.

In particular, the upper connecting part 110 and the lower connecting part 120 are formed to slip around an outer diameter of the rope in accordance with the positions of the plurality of rope groups 30A and 30B which are overlapped or staggered.

That is, the upper connecting part 110 and the lower connecting part 120 have a larger dimension or diameter than the rope so that the upper connecting part 110 and the lower connecting part 120 may slip in accordance with the positions of the plurality of rope groups 30A and 30B, which are overlapped or staggered, and the intermediate connecting part 130 may be folded or unfolded.

In this case, the intermediate connecting part 130 may be made of a material such as a belt or rubber, thereby ensuring flexibility while the plurality of movable bodies 20 and the rope groups 30A and 30B are staggered or overlapped.

Further, the intermediate connecting part 130 has a predetermined length to maintain predetermined tension thereof at the position at which the plurality of rope groups 30A and 30B is staggered.

Therefore, according to the present invention as illustrated in FIG. 3, the rope groups 30A and 30B are overlapped as the plurality of movable bodies 20 and the rope groups 30A and 30B are moved upward by the operations of the lift drive units 10, thereby ensuring the space through which the passenger may enter the train.

At the same time, the interval maintaining unit 100 is curved and folded so that no interference occurs between the plurality of rope groups 30A and 30B.

Next, as illustrated in FIG. 4, the plurality of movable bodies 20 and the rope groups 30A and 30B are moved downward by the reverse operations of the lift drive units 10 so that the rope groups 30A and 30B are staggered to block the passenger, and the interval maintaining unit 100 connects, in the vertical direction, the rope groups 30A and 30B positioned at the upper and lower sides and maintains tension thereof, thereby preventing the passenger from entering and passing between the rope groups 30A and 30B.

In particular, the interval maintaining unit 100 connects, in the vertical direction, the rope groups 30A and 30B positioned at the upper and lower sides, thereby minimizing sagging and swaying of the rope groups 30A and 30B positioned at the lower side.

While the exemplary embodiment of the present invention has been described above in detail, the scope of the present invention is not limited to the exemplary embodiment, and the substantial equivalents to the exemplary embodiment of the present invention are of course included in the scope of the present invention.

What is claimed is:

1. A train platform safety device for preventing a safety accident, the train platform safety device comprising:
at least one pair of lift drive units installed at a position selected in a section from an entrance of a platform, where a train enters, to an exit of the platform;
a plurality of movable bodies provided inside the lift drive units so as to be movable in a vertical direction;
rope groups comprising a plurality of ropes connecting the movable bodies in a horizontal direction; and
an interval maintaining unit configured to connect, in the vertical direction, any one rope in the rope group positioned at an upper side and any one rope in the rope group positioned at a lower side so that a vertical interval between the rope groups is maintained when the rope groups are staggered as the plurality of movable bodies and the rope groups are moved downward by operations of the lift drive units.

2. The train platform safety device of claim 1, wherein the lift drive unit comprises:
a main body provided in the vertical direction at a predetermined position on the platform;
two or more rotary bodies having different diameters and installed at upper and lower sides inside the main body, respectively;
a drive mean provided to rotate the rotary bodies to move the movable bodies in the vertical direction so that the plurality of movable bodies is overlapped by being moved upward or staggered by being moved downward; and
a connecting body configured to connect the rotary bodies and the drive means.

3. The train platform safety device of claim 1, wherein the interval maintaining unit comprises:
an upper connecting part provided to be connected to any one rope in the rope group positioned at the upper side;
a lower connecting part provided to be connected to any one rope in the rope group positioned at the lower side; and
an intermediate connecting part configured to connect the upper connecting part and the lower connecting part and made of a soft material so as to be changed in shape in accordance with the positions of the plurality of rope groups which are overlapped or staggered.

4. The train platform safety device of claim 3, wherein the upper connecting part and the lower connecting part are formed to slip around an outer diameter of the rope in accordance with the positions of the plurality of rope groups which are overlapped or staggered.
